(19) United States
(12) Patent Application Publication
(10) Pub. No.: US 2017/0250533 A1
(43) Pub. Date: Aug. 31, 2017

(54) Method and Apparatus for Eliminating Harmonic Components and Obtaining a Uniform Power Factor in Alternating Current-Direct Current and Direct Current-Alternating Current Converters

(71) Applicant: Universidade Federal de Minas Gerais - UFMG, Belo Horizonte (BR)

(72) Inventors: Braz de Jesus Cardoso Filho, Belo Horizonte (BR); Thiago Morais Parreiras, Belo Horizonte (BR)

(21) Appl. No.: 15/512,468

(22) PCT Filed: Sep. 17, 2015
(86) PCT No.: PCT/IB2015/057182

§ 371 Date: Mar. 17, 2017

(30) Foreign Application Priority Data
Sep. 17, 2014 (BR) BR1020140230572

(51) Int. Cl. H02J 3/01; H02M 1/42; H02P 27/08; H02P 23/26; H02M 1/12; H02M 5/458

(52) U.S. Cl. CPC H02J 3/01; H02M 1/12; H02M 5/4585; H02P 27/08; H02P 23/26; H02M 1/4216

(57) ABSTRACT

The present patent application relates to a method and equipment for eliminating harmonics based on two complementary techniques, namely the elimination of harmonics by selective harmonic elimination pulse-width modulation in conjunction with the multiple-wiring transformer. The association of these two resources is capable of reducing the harmonic distortion of currents to extremely low values, providing a truly unitary power factor. The technology is suitable for low and medium intensity alternating current—direct current and direct current—alternating current converters, which make interface with the electricity network and should have low harmonic distortion of the current because of the high power value involved, and also because of fragility of the electricity network (low power of short circuit at the coupling point).

The present patent application comprises method and equipment for eliminating harmonics based on two complementary techniques, namely selective harmonics elimination through pulse width modulation (SHE PWM) in conjunction with the multiple wiring transformer. The association of these two resources is capable of reducing the harmonic distortion of current to extremely low values, providing a truly unitary power factor. The technology is suitable for alternating current—direct current and direct current—alternating current converters of low and medium voltage, which make interface with the electric network and must have low harmonic distortion of the current because of the high power value involved, and also because of fragility of the electric network (low short-circuit power at the coupling point).

The use of three-phase power converters has become usual in industrial and electrical system applications, however, the larger the amount of power to be converted by this equipment the greater the problems related to the quality of energy. These converters (non-linear charges) require non-sinusoidal currents from the electricity network (source of sinusoidal voltage). These currents, in turn, cause a drop in non-sinusoidal voltage in the impedance of the system, giving rise to voltage distortions at the terminals of the charge itself and of others that share the same electrical system. These currents and distorted voltages can be composed by a sum of the fundamental sinusoid (at the same frequency of the network) and of various other sinusoids of multiple frequencies of the fundamental (harmonics) (J. Arrilaga dna N. R. Watson, Power Systems Harmonics, 2^{nd} ed. Chichester, England: John Wiley & Sons, 2003).

The presence of these harmonics in an electrical system may cause in-series or parallel resonance with the installed capacitors, for example, for correction of displacement power factor, leading to excessive currents and damage to these capacitors; increase in loss in the copper and iron of transformers and electric machines, causing greater heating of the latter, with possibility of failure of the equipment; torque pulsations on the electric machines, preventing correct control of the charge and causing greater mechanical stress to the equipment; greater loss on electric conductors due to the higher RMS value of the current and the presence of high frequencies (film and proximity effects are a function of the frequency), leading to the need for oversizing the conductors; poor functioning of electronic and telecommunication devices.

Recommended limits and practices for keeping the harmonics at acceptable levels in electrical systems are established in the rule IEEE Std 519 (IEEE Recommended Practices and Requirements for Harmonic Control in Power Systems, IEEE STANDARD 519, 1992). The rule IEEE Std 1547 establishes stricter limits in the cases of sources of distributed generation interconnected to the electrical system. The rule IEC 61000-4-7, in turn, establishes the harmonics measuring techniques in energy supplying systems (IEEE Standard for Interconnecting Distributed Resources with Electric Power Systems, IEEE Standard 1547, 2003) (Electromagnetic compatibility (EMC)—Part 4-7: Testing and measurement techniques—General guide on harmonics and interharmonics measurements and instrumentation, for power supply systems and equipment connected thereto, IEC Standard 61000-4-7, 2009).

Besides analyzing the amplitude of each harmonic component (usually with respect to the fundamental), two other indicators are used to indicate qualitatively and quantitatively the degree of distortion of the currents and voltages in a system. They are that of total harmonic distortion (THD), used for voltages and currents, and that of total demand distortion (TDD), used for currents so as to differentiate, to take into account the charge conditions during the measurements (J. Arrilaga and N. R. Watson, Power Systems Harmonics, 2^{nd} ed. Chichester, England: John Wiley & Sons, 2003) (IEEE Recommended Practices and Requirements for Harmonic Control in Power Systems, IEEE Standard 519, 1992). The two indicators are represented in [1] and [2], wherein they become the same value in the conditions in which the fundamental current is equal to the nominal current of the equipment, a condition that will be considered hereinafter.

$$\begin{matrix}THD = \frac{\sqrt{{\sum }_{n = 2}^{N} {V}_{n}^{2}}}{{V}_{1}} & [ 1 ] \\ TDD = \frac{\sqrt{{\sum }_{n = 2}^{N} {I}_{n}^{2}}}{{I}_{R}} & [ 2 ]\end{matrix}$$

Wherein n is the order of the evaluated harmonics and N is the order of the greater harmonic to be considered in the composition of the indicator. Although theoretically N can be as great as desired, the rule IEEE Std. 519 establishes it as being 50 (IEEE Recommended Practices and requirements for Harmonic Control in Power Systems, IEEE STANDARD 519, 1992), which also meets the IEC 61000-4-7, which establishes the minimum value of 40, and the IEEE Std. 1566, which establishes that the harmonics up to order 49 should be evaluated in the case of converters for driving high-power motor (Electromagnetic compatibility (EMC)—Part 4-7: Testing and measurement techniques—General guide on harmonics and interharmonics measurements and instrumentation, for power supply systems and equipment connected thereto, IEC Standard 6100-4-7, 2009)). (IEEE Standard for Performance of Adjustable Speed AC Drives Rated 375 kW and Larger, IEEE Standard 1566, 2005).

In the presence of these harmonics, the power factor of an installation or equipment fails to be only the cosine of the off-phase angle between the voltage and the fundamental current, but also incorporates the harmonics of voltage and current in its calculation, as shown in [3] below, This is the so-called true power factor (W. M. Grady and R. J. Gilleskie, “Hamonics and how they relate to power factor”, presented at Proc. EPRI Power Quality Issues & Opportunities Conf. San Diego, Calif., Nov. 1993).

$${pf}_{true} = \frac{{P}_{avg 1}}{{V}_{1 rms} \cdot {I}_{1 rms}} \cdot \frac{1}{\sqrt{1 + {THD}_{I}^{2}}} \qquad [ 3 ]$$

The truly unitary power factor depends then on two factors: voltage and fundamental current in phase and absence of significant harmonics of voltage and current. The first requirement is inherent on passive rectifiers in diodes and can be easily obtained on active rectifiers through adequate control of current on components dq (N. Mohan, T. M. Undeland and W. P. Robbins, Power Electronics: Converters, Applications, and Design, 3^{rd} ed. Hoboken, NJ: John Wiley & Sons, 2003) (A. Yazdani and R. Iravani, Voltage-Source Converters: Modeling, Control and Applications, 1^{st} ed. Hoboken, N.J.: John Wiley & Sons, 2010). On the other hand, the second requirement, the reduction of harmonics, is more complex and is a function of the topology of the converter, of the modulation technique adopted and of some additional method of reduction of harmonics (A.-S.A. Luiz and B. J. C. Filho, “Sinusoidal voltages and currents in high power converters”, in 34^{th} Annual Conference of IEEE Industrial Electronics, Orlando, Nov, 2008, pp. 3315-3320).

The use of passive rectifiers in three-phase systems causes the appearance of harmonics on the order of h=6 k +/−1, wherein k=1, 2, 3 . . . (J. Arrilaga and N. R. Watson, Power Systems Harmonics, 2^{nd} ed. Chichester, England: John Wiley & Sons, 2003) (N. Mohan, T. M. Undeland and W. P. Robbins, Power Electronics: Converters, Applications, and Design, 3^{rd} ed., Hoboken, N.J.: John Wiley & Sons, 2003). The reduction in the number of harmonics produced may takes place, in this case, by using multiple-wiring transformers, wherein each wiring feeds a rectifier and the angular off-phase between the wirings is properly chosen, so that, in the primary, one obtains greater elimination of harmonics (B. Singh et al., “Multipulse AC-DC converters for improving power quality: A review”, IEEE Trans. Power Electron., vol. 23, no. 01, pp, 260-281, January 2008). In this way, the number of secondary wirings (x) defines how many harmonics will be eliminated and the characteristic harmonics in the primary may be generalized by h=6xk +/−1.

A single three-phase transformer of three wirings (Delta-delta-star), for example, generates the necessary off-phase (30°) between its wirings to have on the primary only the harmonics of order h=12 k +/−1. Although transformers of more wirings may be used by decreasing even more the number of harmonics, as occurs with the cascade multilevel converter in which, depending of the level of voltage, transformers of up to 15 wirings can be used (P. W. Hammond, “A new approach to enhance power quality for medium voltage drives”, in Industry Applications Society 42^{nd} Annual Petroleum and Chemical Industry Conf., Denver, Colo., 1995, pp. 231-235), this large amount of wirings, combined to the non-conventional off-phase that should exist between them for cancellation of harmonics to occur, brings great complexity and high costs in the production of transformers.

An alternative solution to the use of so complex transformers is by using active converters in which one has control over the triggering of the power semiconductor devices (J. R. Rodriguez et al, “PWM regenerative rectifiers: state of art”, IEEE Trans. Ind, Electron., vol. 52, no. 01, pp. 5-22, February 2005). These converters, which are regenerative by nature, can be made, as is the case with the inserting part, in two, three or more levels. The larger the number of levels, the lesser the harmonic distortion of the current required by the converter. In medium-voltage converter, it is already common to use topologies of at least three levels due to the maximum voltage limitation itself of the switches (IGBT and IGCT), which are presently found on the market (A. Volke and M. Hornkamp, IGBT Modules: Technologies, Driver and Application, 1^{st} ed. Munich, Germany: Infineon, 2011), (J. Rodriguez et al., “Multilevel voltage-source-converter topologies for industrial medium-voltage drives”, IEEE Trans. Ind. Electron,, vol. 54, no. 06, pp. 2930-2945, December 2007).

The most widely known three-level topologies are that of three-level converter (NPC (Neutral Point Clamped) and that of three-level converters ANPC (Active Neutral Point Clamped) or NPP (Neutral Point Piloted) (A. Nabae, I. Takahashi, H. Akagi, “A new neutral-point-clamped PWM inverter”, IEEE Trans, Ind. Appl., vol. IA-17, no. 05, pp. 518-523, September/October, 1981). (T, Brückener, S. Bernet, and H. Güldner, “The active NPC converter and its loss-balancing control,” IEEE Trans. Ind. Electron., Vol. 52, no. 3, pp. 855-868, June 2005), V, Guennegues, et al., “A converter topology for high speed motor drive applications”, in European Conf. Power Electronics and Applications, Barcelona, Spain, 2009, pp. 1-8). For the cases in which the convertor feeds a charge in which there is no need for regeneration, alternatives have already been presented for both low voltage and medium voltage of three-level converters that have only the rectifying capacity, keeping in a minimum the same quality of energy of the three-level generative topologies and with the use of a reduced number of semiconductor devices (J. W. Kolar and F. C. Zach, “A novel three-phase utility interface minimizing line current harmonics of high-power telecommunications rectifier modules”, IEEE Trans. Ind, Electron,, vol. 44, no. 04, pp. 456-467, August 1997), (Y, Zaho, Y. Li, T, A. Lipo, “Force commutated three level boost type rectifier”, in Industry Applications Society Annual Meeting, Toronto, Canada, 1993, pp. 771-777), (M. L. Heldwein, S. A, Mussa, I. Barbi, “Three-phase multilevel PWM rectifiers based on conventional bidirectional converter”, IEEE Trans. Power Electron., vol. 25, no. 03, pp. 545-549, March 2010).

Although there are various topologies with even more than three levels, like those that make use of flying capacitor, these topologies gain much in complexity and lose cost and reliability due to the increase in the number of components (J. Rodriguez et al., “Multilevel voltage-source-converter topologies for industrial medium-voltage drives”, IEEE Trans. Ind. Electron., vol. 54, no. 06, pp. 2930-2945, December 2007). Besides, even the use of three-level converters at low voltage is not very acceptable, since the number of switches is multiplied, at the least, by three with respect to the alternative of two levels.

The pulse-width modulation techniques (PWM) also exert important influence on the harmonic contents of the voltages and currents demanded by active converters. Although the PWM techniques already are widespread, based on carrier waves and space vectors, the limitations imposed on the switching frequency due to the losses on convertors for high-power applications cause harmonics of lower orders to appear (A. M. Hava, R. J. Kerkman, T. A. Lipo, “Single analytical and graphical methods for carrier-based PWM-VSI drives”, IEEE Trans. Power Electron, vol. 14, no. 01, pp. 49-61, January 1999). These harmonics of lower order may have their amplitude reduced by applying LCL filters (M. Liserrre, F. Blaabjerg, S. Hansen, “Design and control of an LCL-filter-based three-phase active rectifier”, IEEE Trans. Ind. Appl., vol., 41, no. 05, pp. 1281-1291, September/October 2005), but the necessary reactive elements have reasonable cost and size and diminish the total efficiency of the assembly (especially when passive dampening of the filter is necessary).

An alternative that, even with low switching frequencies, presents higher-order harmonics is the selective harmonic elimination (SHE) technique (R. G. Hoft, H. S. Patel, “Generalized techniques of harmonic elimination and voltage control in thyristor inverters: Part I—Harmonic elimination”, IEEE Trans. Ind. Appl., vol. IA-9, no. 03, pp. 310-317, May/June 1973), (R. G. Hoft, H. Patel, “Generalized techniques of harmonic elimination and voltage control in thyristor inverters: Part II—Voltage control techniques”. IEEE Trans. Ind. Appl., vol. IA-10, no. 05, pp. 666-673, September/October 1974). Although this technique is more difficult to implement and raises its first non-eliminated harmonics (B. K. Bose, Modern Power Electronics, and AC Drives, 1^{st} ed. Upper Saddle River, N.J.: Prentice Hall, 2002), these well-known harmonics of higher order can be eliminated through filters with smaller reactive elements and through the use of resonant arms (A.-S.A. Luiz, B. J. C. Filho, “Analysis of passive filters for high power three-level rectifiers”, 34^{th} Annual Conf. IEEE Industrial Electronics, Orlando, 2008, pp. 3207-3212), (A.-S.A. Luiz, B. J. C. Filho, “Minimum reactive power filter design for high power converters”, in 13^{th} Power Electronics Motion Control Conf., Poznan, Poland, 2008, pp. 1345-1352).

According to J. Pontt et al., a topology is proposed for the purpose of meeting the requirements of the IEEE Std. 519, using a combination of three-level converters, SHE PWM modulation (for 3 and 5 pulses) and three-wiring transformer (J. Pontt, J. Rodriguez and R. Huerta, “Mitigation of noneliminated harmonics of SHE PWM three-level multiphase three-phase active front end converters with low switching frequency for meeting standard IEEE-519-92”, IEEE Trans. Power Electron., vol. 19, no. 06, pp. 1594-1600, November 2004), (IEEE Recommended Practices and Requirements for Harmonic Control in Power Systems, IEEE Standard 519, 1992). This proposition proved to be effective in reducing the harmonics to interesting levels with low switching frequency and without using filters with capacitive elements. However, it is still not capable of producing a truly unitary power factor, because it still has harmonics within the ranges applicable in the calculation of [1] and [3] (IEEE Recommended Practices and Requirements for Harmonic Control in Power Systems, IEEE Standard 519, 1992), (Electromagnetic compatibility (EMC)—Part 4-7:Testing and measurement techniques—General guide on harmonics and interharmonics measurements and instrumentation, for power supply systems and equipment connected thereto, IEC Standard 61000-4-7,2009), (IEEE Standard for Performance of Adjustable Speed AC Drives Rated 375 kW and Larger, IEEE Standard 1566,2005). Besides, because this topology uses only three-level converters, it still presents a high cost for low-voltage applications due to the use of an excessive number of semiconductor elements.

Document U.S. Pat. No. 5,835,364, entitled “HARMONIC ELIMINATING PWM CONVERTER” of Nov. 10, 1998, relates to a converter that uses transformer and PWM modulation, but not the harmonics selective elimination technique. The need to use capacitor banks is an unfavorable characteristic for the use thereof.

The equipment proposed in the present invention is a converter capable of eliminating harmonics and operating with unitary power factor. The functioning characteristics presented herein are achieved by means of the process that uses two complementary strategies, namely selective harmonics elimination through pulse-width modulation associated to the use of multiple-wiring transformer.

### BRIEF DESCRIPTION OF THE FIGURES

FIG. 1—FIG. 1 shows the generic topology of the converter proposed and its basic elements: a conventional three-wiring transformer (2), (3) and (4) with connections Dd0y1 or Dd0y11 (according to IEC 60076-1) having its primary (2) connected to the electrical network (1) and each of its secondary (3) and (4) connected to a converter (6) switching through the 9-pulse SHE PWM method. The output in direct current of the converters may be kept at individual bars FIG. 1(b) to enable a parallel connection of the converters on the side of the charge and thus greater current available, or be connected in series FIG. 1(a) to obtain a higher voltage value on the direct-current bar.

FIG. 2—FIG. 2 indicates a conventional two-level converter with converting or inverting operation capacity.

FIG. 3—FIGS. 3 indicates a phase representation of the NPC three-level converter topology with operation capacity in four quadrants.

FIG. 4—FIG. 4 indicates a phase representation of the ANPC three-level converter with operation capacity in four quadrants.

FIG. 5—FIG. 5 indicates a phase representation of the NPP three-level converter with operation capacity in four quadrants.

FIG. 6—FIG. 6 indicates a phase representation of the Vienna converter topology, in which there is only the possibility of power flow in the converter-to-charge direction.

FIG. 7—FIG. 7 shows a phase representation of the three-level raising converter with forced commutation, in which there is only the possibility of power flow in the converter-to-charge direction,

FIG. 8—FIG. 8 shows a phase representation of the three-level converter topology in the NPC topology, in which there is only the possibility of power flow in the converter-to-charge direction.

FIG. 9—FIG. 9 shows a phase representation of the three-level converter topology, based on the NPP topology, in which there is only the possibility of power flow in the converter-to-charge direction.

FIG. 10—FIG. 10 shows two topologies, in which multi-level converters (10), (11) are used to feed a motor or generator (12) at voltages of up to 9 kVrms. The direct current bar can be connected in series, enabling one to obtain 5 voltage levels from the converter and, consequently, being possible to use a converter at 5 levels (10) on the side of the machine (FIG. 10(a)). Alternatively, the direct current bar can independently feed converters at 3 levels (11), which feed a machine with the 6 accessible terminals of the coil (FIG. 10(b).

FIG. 11—FIG. 11 shows the simulation data for a two-level converter. The simulated data are related to a phase, represented in the figure as phase A. In the first graph, on the ordinate axis, the voltage is represented at Volts, switched by the converter, evidenced by the pulses in square wave; the sinusoidal reference associated to the pulses resulting from the PWM modulation is represented in the same graph; the time in seconds is represented on the abscissa axis. The harmonic spectrum resulting from the voltage switched by the converter is represented in the second graph; the voltage of the harmonics expressed as a percent value with respect to the amplitude of the voltage of the fundamental component is represented on the ordinate axis; the order of the harmonics is represented on the abscissa axis.

FIG. 12—FIG. 12 shows the simulation data for a two-level converter. The simulated data are related to a phase, represented in the figure as phase A. In the first graph, the current on the secondary wiring of the transformer in Amperes is represented on the ordinate axis; the time in seconds is represented on the abscissa axis. The harmonic spectrum associated to the current that circulates in the secondary wiring of the transformer is represented in the second graph. The current intensity of each harmonic expressed as a percentage value with respect to the amplitude of the current of the fundamental component is represented on the ordinate axis; The order of the harmonics is represented on the abscissa axis.

FIG. 13—FIG. 13 shows the simulation data for a two-level converter. The simulated data are related to a phase, represented in the figure as phase A. In the first graph, the current on the primary wiring of the transformer in Amperes, reflected from the secondary wiring (primary and secondary in Delta connection) is represented on the ordinate axis; the time in seconds is represented on the abscissa axis. In the second graph, the current in the primary wiring of the converter in Amperes, reflected from the secondary wiring (primary in delta and secondary in star) is represented on the ordinate axis; the time in seconds is represented on the abscissa axis. In the third graph, one represents the total current in the primary wiring of the converter in Amperes, reflected from the two secondary wirings, is represented on the ordinate axis; the time in second is represented on the abscissa axis.

FIG. 14—FIG. 14 shows the simulation data for a two-level converter. The simulated data relates to a phase, represented in the figure as phase A. The harmonic spectrum associated to the total current that circulates on the primary wiring of the transformer in Ampere is represented in the graph; The current intensity of each harmonic, expressed as a percentage value, with respect to the amplitude of the current of the fundamental component is represented on the ordinate axis; The order of the harmonics is represented on the abscissa axis. The total harmonic distortion of the current that circulates through the primary wiring of the transformer equal to 0.582% is indicated in the graph.

FIG. 15—FIG. 15 shows the simulation data for a three-level converter. The simulated data relates to a phase, represented in the figure as phase A. In the first graph, the voltage in Volts, switched by the converter, evidenced by the pulses in square wave is represented on the ordinate axis; The sinusoidal reference associated to the pulses resulting from the PWM modulation is represented in the same graph; the time in seconds is represented on the abscissa axis. The harmonic spectrum resulting from the voltage switched by the converter is represented in the second graph; The voltage of the harmonics expressed as a percentage value with respect to the amplitude of the voltage of the fundamental components is represented on the ordinate axis; the order of the harmonics is represented on the abscissa axis.

FIG. 16—FIG. 6 shows the simulation data for a three-level converter. The simulated data relates a phase, represented in the figure as phase A, In the first graph, the current on the secondary wiring of the transformer in Ampères is represented on the ordinate axis; the time in seconds is represented on the abscissa axis. The harmonic spectrum associated to the current that circulates in the second wiring of the transformer is represented in the second graph; the current intensity of each harmonic component expressed as a percentage value with respect to the amplitude of the current of the fundamental component is represented on the ordinate axis; the order of the harmonics is represented on the abscissa axis.

FIG. 17—FIG. 17 shows the simulation data for a three-level converter. The simulated data relates to a phase, represented in the figure as phase A. In the first, graph, the current on the primary wiring of the transformer in Amperes, reflected from the secondary wiring (primary and second Delta connection) is represented on the ordinate axis; the time in seconds is represented on the abscissa axis. In the second graph, the current on the primary wiring of the transformer in Ampères, reflected from the secondary wiring (primary in delta and secondary in star) is represented on the ordinate axis; the time in seconds is represented on the abscissa axis. In the second graph, the total current on the primary wiring of the transformer in Ampère, reflected from the two secondary wirings is represented on the ordinate axis; the time in seconds is represented on the abscissa axis.

FIG. 18—FIG. 18 shows the simulation data for a three-level converter. The simulated data relates to a phase, represented in the figure as phase A. The harmonic spectrum associated to the total current that circulates on the primary wiring of the transformer in Ampères is represented in the graph; the current intensity of each harmonic component expressed as a percentage value with respect to the amplitude of the current of the fundamental component is represented on the ordinate axis; the order of the harmonic components is represented on the abscissa axis. The total harmonic distortion of the current that circulates through the primary wiring of the transformer equal to 0.1% is indicated in the graph.

### DETAILED DESCRIPTION OF THE TECHNOLOGY

The present technology involves a method and a piece of equipment to eliminate harmonics,

The method for elimination of harmonics comprises the following steps:
a) eliminating harmonics of the h order, defined by the expression h=6 k +/−1, by using three-wiring transformers, wherein k={1,3,5,7 . . . };
b) eliminating harmonics of h order, defined by the expression h=12 k+/−1, wherein k={1,2,3,4, . . . }, y using selective harmonic elimination pulse-width modulation (SHE PWM).

The order of harmonics to be eliminated at steps “a′ and “b” may be equal to or higher than 50. At step “b” the most indicated SHE PWM type of modulation is that of 9 pulses.

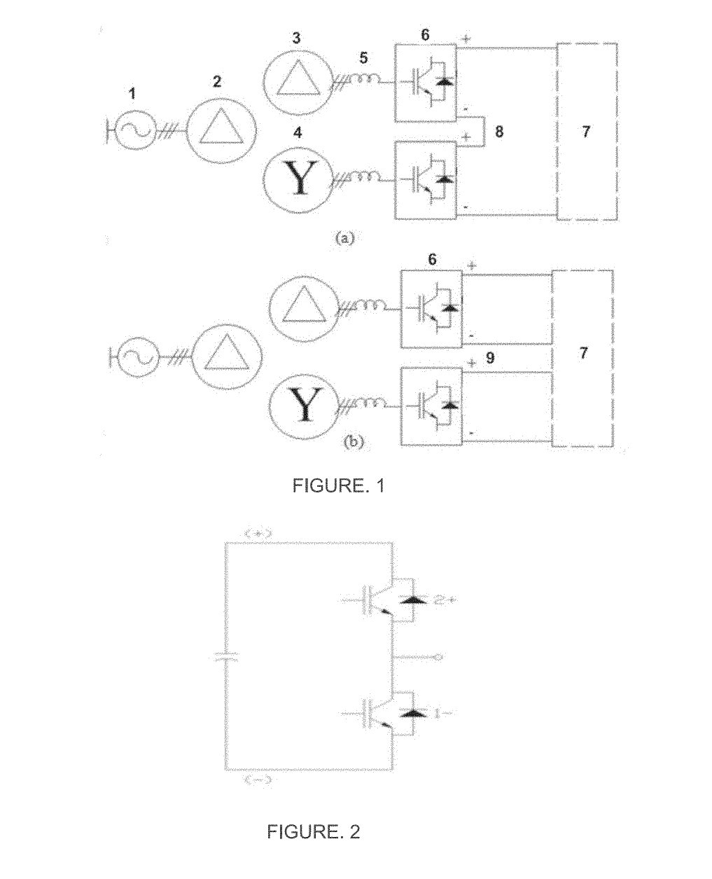

The proposed equipment is a converter capable of eliminating harmonics and operating with unitary power factor. The functioning characteristics presented are achieved by means of the method described above, which uses two complementary strategies, namely selective harmonic elimination by pulse-width modulation associated to the use of a multiple wiring transformer. The non-limiting generic topology of the device is presented in FIG. 1. The equipment comprises a multiple wiring transformer composed by primary wiring (2), at least one pair of secondary wirings, one configured delta connection (3) and the other configured in star (4); wherein each secondary wiring is connected individually to a converter (6) switched by means of pulse-width modulation with selective harmonic elimination. The proposed equipment may contain multiple pairs of secondary wiring (3), and (4) connected to multiple converters (6), configuring repetitions of the basic unit, which includes a pair of secondary wirings (3) and (4) and the converters connected individually to these wirings.

The reduction of the number of harmonics produced occurs by using multiple-wiring transformers, wherein each wiring feeds a converter, and the angular off-phase between the wirings is chosen so that in the primary wiring an elimination of harmonics is obtained. In this way, the number of secondary wirings defines how many harmonics will be eliminated. A single three-phase three-wiring transformer (Delta-delta-star), for example, generates the necessary off-phase (30°) between its wirings so as to have in the primary one only the harmonics of the h order (defined by the expression h=12 k +/−1, wherein k={1, 2, 3 . . . }). The obtainment of the sinusoidal current on the first primary wiring of the transformer (free from harmonics up to the order 50) also takes place due to the fact that the converters in question have the SHE PWM angles calculated so as to eliminate the harmonics that are not eliminated by the connection of the transformer itself, which are those of the h order (defined by the expression h=12 k +/−1, wherein k={1,2,3,4 . . . }), by using pulse-width modulation with selective harmonic elimination (SHE PWM), as indicated in Table 1, which shows the values of harmonics to be eliminated in that case where the number of wirings of the transformer is equal to three. The even pairs are not characteristics due to the symmetry of one fourth of wave and the triple harmonics are cancelled between phases due to three-wire three-phase connection.

TABLE 1
orders of the harmonics eliminated by each element.

| | Harmonics to be eliminated |
|---|---|
| Element | (order) |
| Transformer | 5, 7, 17, 19, 29, 31, 41, 43 |
| (three wirings) | |
| Convert (SHE | 11, 13, 23, 25, 35, 37, 47, 49 |
| PWM, nine pulses) | |

The output of the direct current of the converters may be kept on individual bars (FIG. 1(b)) to enable a parallel connection of the converters on the charge side and so to obtain greater current available, and it may also be connected in series to obtain a higher voltage value on the direct-current bar (FIG. 1(a)). The voltage and current measurements necessary to the synchronism with the network and to the control of the converter may be take on both the primary side (preferable) and the secondary ones.

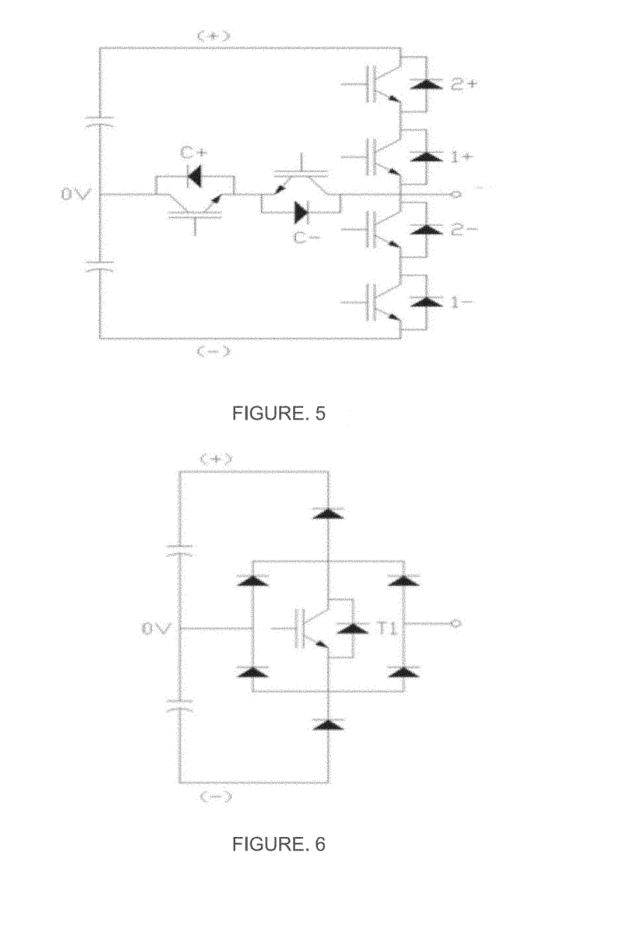

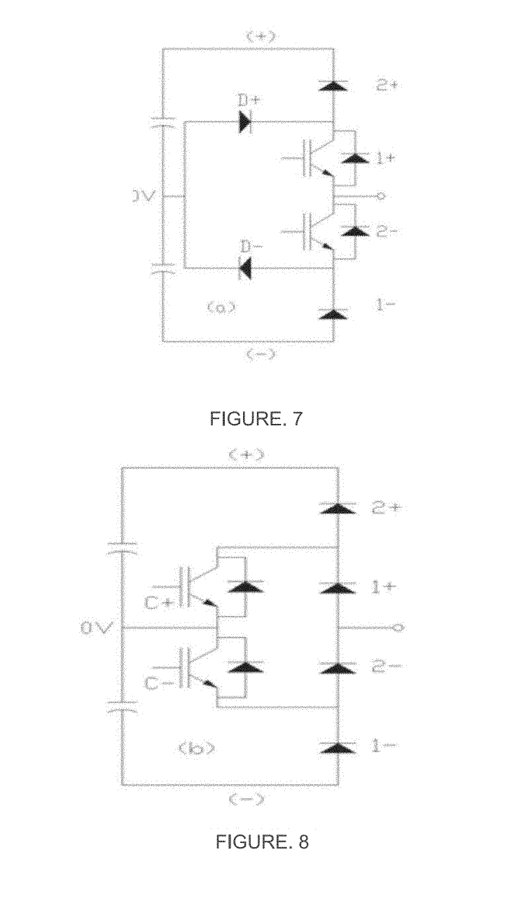

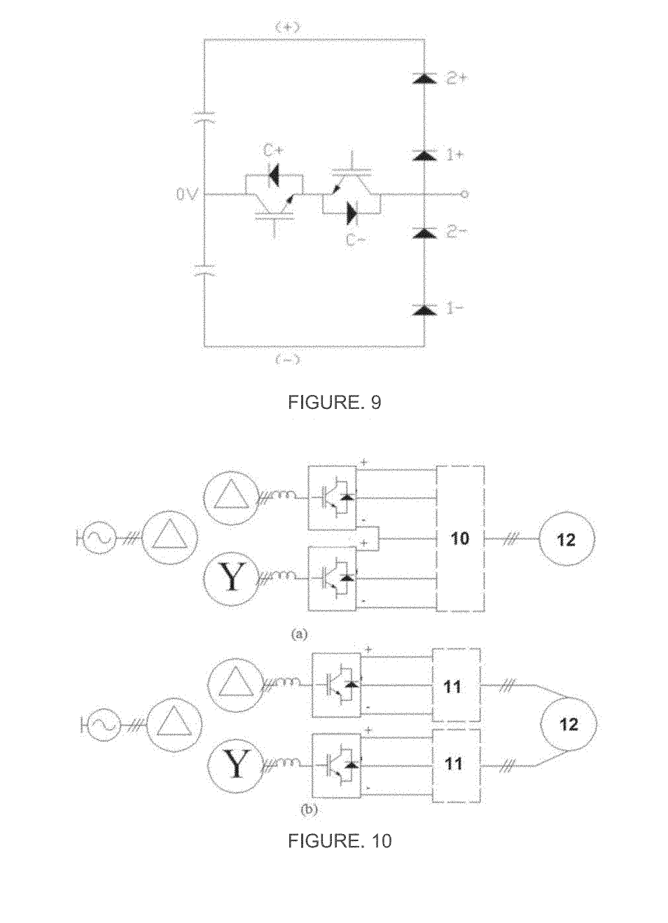

The converters (6) may have different topologies according to the levels of voltage and current involved in the commutation and blockage of the switches, as well as the need or no need for bidirectional power flow. FIGS. 2-9 indicate the multilevel topologies that may be adopted for the converters, and may be of the types: NPC, ANPC, NPP, Vienna Converter, raising Converter with forced commutation.

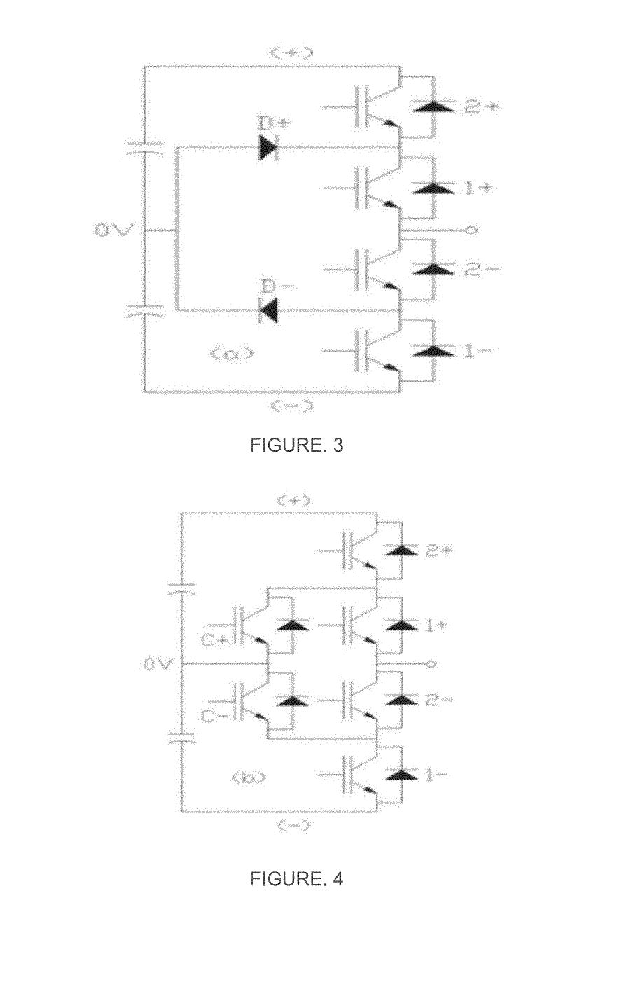

FIG. 2 indicates a conventional two-level converter with converting or inversing operation capacity. The other figures indicate three-level topologies, wherein the topologies presented in FIGS. 3-5 indicate the converters NPC, ANPC and NPP, respectively. All these also with operation capacity in four quadrants. On the other hand, FIGS. 6-9 indicate the possible three-level topologies, wherein there is only the need for power flow in the converter-to-charge direction and, therefore, the number of active switches may be reduced.

FIG. 10 shows an application of the method proposed herein in a preferred configuration of the converter, wherein it is implemented with a transformer with two secondary wirings (3) and (4), three-level converters (6) (FIGS. 3-5 and 7-8) for elimination of a motor (12) or generator (12) on voltages on the order of up to 9 kVrms. The direct-current bar may be connected in series, enabling one to obtain five voltage levels (10) from the converter and, as a result, it is possible to use a inverter at 5 levels on the machine side (FIG. 10(a)), or the direct-current bars can feed, in an independent way, converters at 3 levels (11), which feed a machine with the six accessible terminals of the coil (FIG. 10(b)). This is the less complex configuration of the equipment, since it uses the smaller number of transformer wirings and, therefore, is economically interesting and reliable.

The invention can be better understood through the use of examples, including but not limited to:

### EXAMPLE 1

### Results of the Simulations Carried Out

Results of the simulations carried out by using the tools Simulink® of the MATLAB® for both a low-voltage system by applying two-level converters (data of the simulated system in table 2) and a medium-voltage application by using three-level converters (data of the simulated system in table 3). The transformer used in the simulation is composed of three wirings.

TABLE 2
Data of the low-voltage simulated system by applying two-level
converters.

| Element/Variable | Simulation Value |
|---|---|
| Network voltage [Vrms] | 13800 |
| Voltage of the secondary [Vrms] | 440 |
| Network frequency [Hz] | 60 |
| Input inductance [mH] | 0.5 |
| Type of SHE PWM [pulses] | 9 |
| Current reference Id [A] | −370* |
| Current reference Iq [A] | 0* |

*referring to each secondary

TABLE 3
Data of the medium-voltage simulated system applying three-level
converters.

| Element/Variable | Simulation Value |
|---|---|
| Network voltage [Vrms- | 13800 |
| Voltage of the secondary [Vrms] | 4160 |
| Network frequency [Hz] | 60 |
| Input inductance [mH] | 4 |
| Type of SHE PWM [pulses] | 9 |
| Current reference Id [A] | −207* |
| Current reference Iq [A] | 0* |

*referring to each secondary

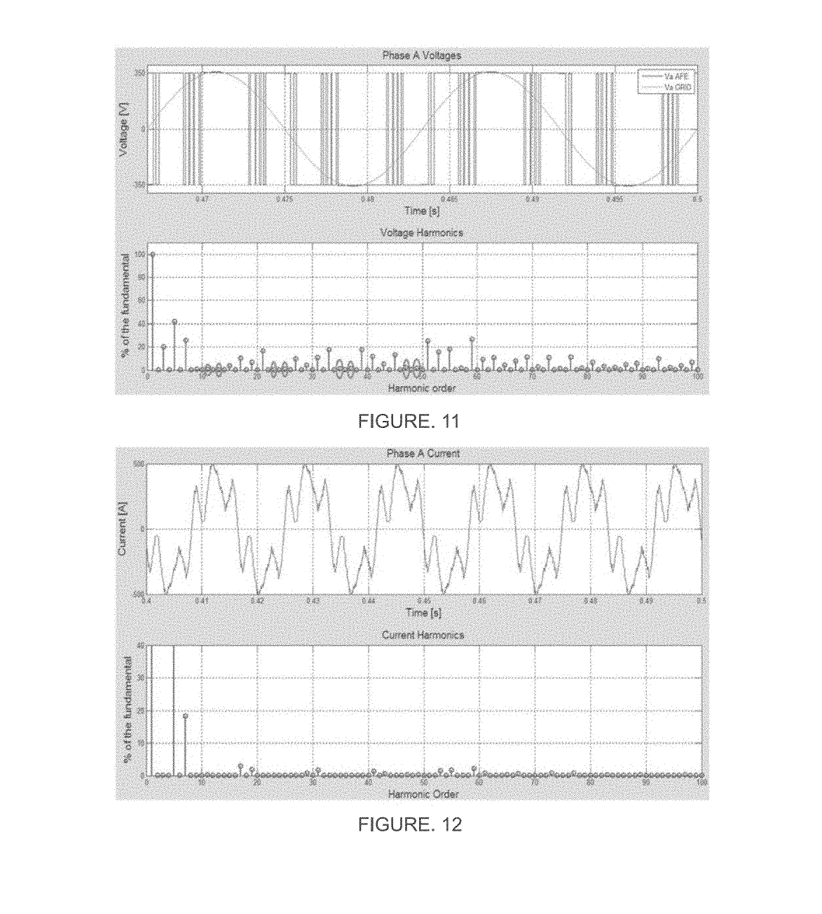

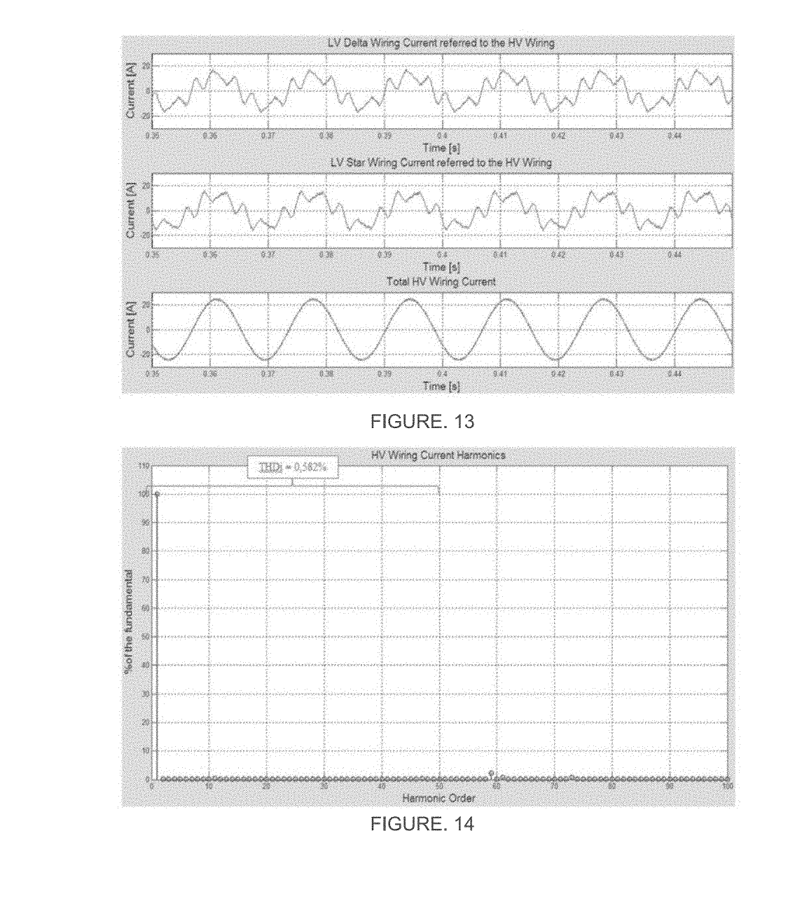

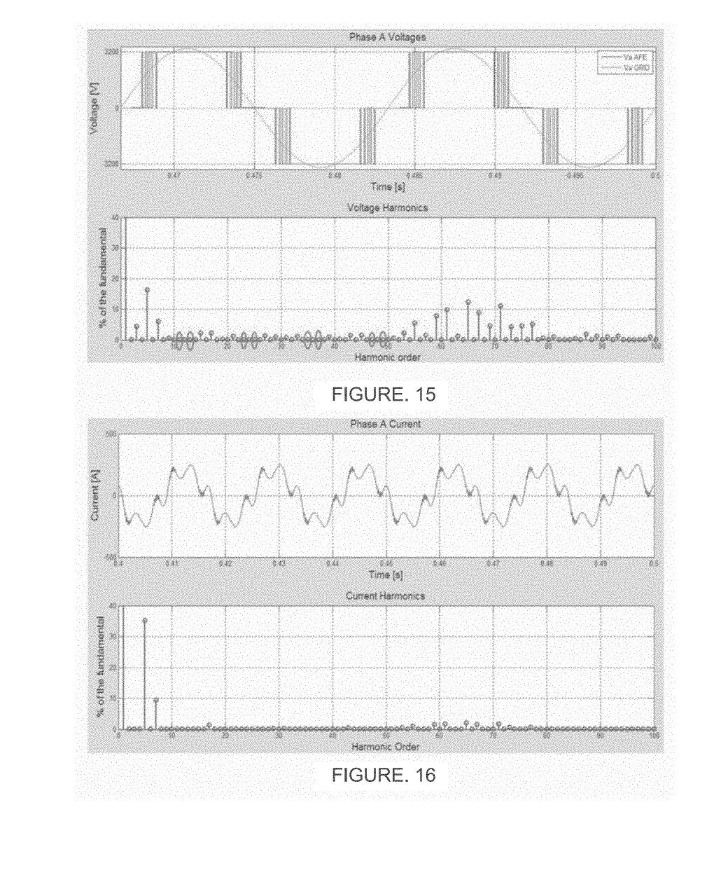

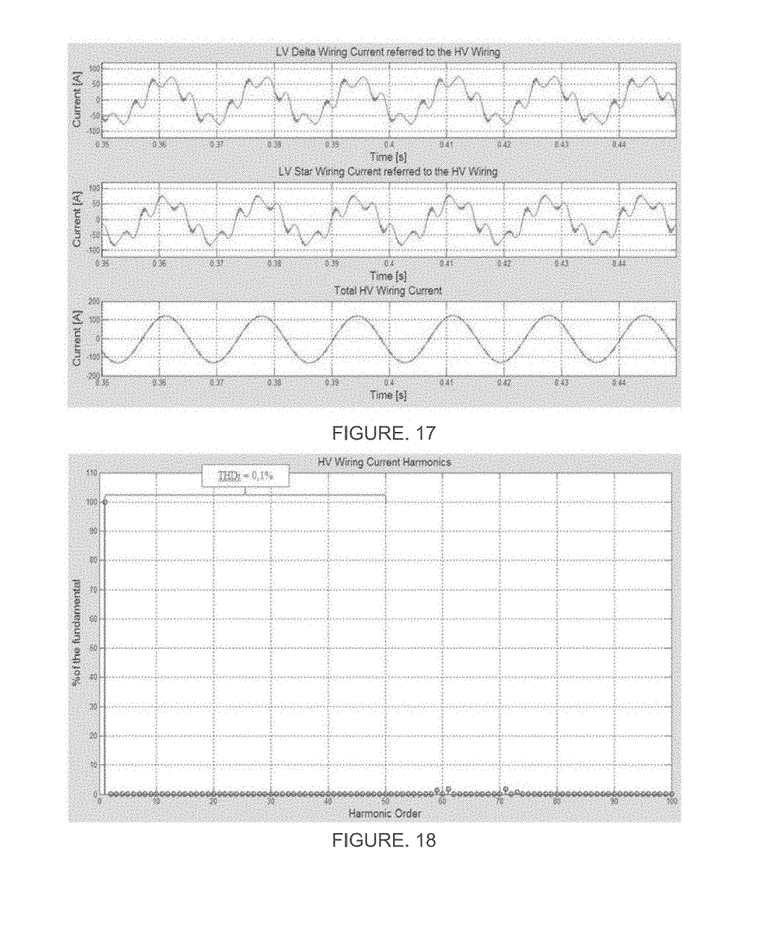

The results achieved from the simulations are arranged in graphs. In FIGS. 11-14 are the results for the simulation of two-level converter, including the voltage waves (and harmonic spectrum) switched by the converter, the current (and spectrum) on the second transformer, the currents of the secondary reflected to the primary and the current resulting on the primary, and the harmonic spectrum of the current on the primary of the transformer, respectively. FIGS. 15-18 indicate the same results for the case of using three-level converters.

In all the results one can observe that, although the currents are highly distorted on the secondary wirings of the transformer, the selective elimination in conjunction with the three-wiring transformer was capable of producing an extremely low total harmonic distortion of current on the primary (calculated up to 50° harmonic). These THD applied in equation [3] result in a truly unitary power factor. This has been achieved with converters whose switching frequencies were 1140 Hz for two-level converters and of 1080 Hz (540 Hz per switch) in the case of three-level converters.

1. A method for eliminating harmonic components comprising the following steps:
a) elimination of harmonic components of order h, defined by the expression h=6 k±1, by using three-winding transformer, where k={1, 3,5,7, . . . };
b) elimination of harmonic components of order h defined by the expression h=12 k±1, where k={1, 2,3,4, . . . }, through pulse-width modulation for use with selective harmonic elimination (SHE PWM).

2. Method for elimination of harmonic components, according to claim 1, steps “a” and “b”, wherein the order of harmonic components to be eliminated may be equal to or greater than 50.

3. Method for elimination of harmonic components in accordance with claim 1, step “b”, wherein the type of pulse-width modulation with selective harmonic elimination (SHE PWM) is preferably 9 pulses.

4. Equipment for elimination of harmonic components comprises a multiple winding transformer composed of a primary winding (2), at least one pair of secondary windings, a configured delta connection (3) and the other in the star connection (4); and each secondary winding is individually connected to a converter (6) switched by means of pulse-width modulation with selective elimination of harmonics.

5. Equipment for elimination of harmonic components, according to claim 4, characterized in that it may contain multiple pairs of secondary windings (3) and (4) linked to multiple converters (6) repetitions of the basic setting unit includes the pair of windings side (3) and (4) and the inverters individually connected to these windings.

6. Equipment for elimination of harmonic components, according to claim 4, characterized in that it contains a multiple transformer windings, preferably two secondary windings.

7. Equipment for removing harmonic components, according to claim 4, characterized by the converters can be associated in series and in parallel.

8. Equipment for elimination of harmonic components, according to claim 4, characterized by the converters can be NPC multilevel types ANPC, NPP, Vienna converter, lift inverter with forced switching.
